(19) United States
(12) Patent Application Publication
(10) Pub. No.: US 2007/0256320 A1
(43) Pub. Date: Nov. 8, 2007

(54) Drying Apparatus and Method

(75) Inventor: William Douglas Pearson, Marce-sur-Esves (FR)

Correspondence Address: THE WEBB LAW FIRM, P.C., 700 KOPPERS BUILDING, 436 SEVENTH AVENUE, PITTSBURGH, PA, 15219, US

(73) Assignee: GREENBANK TECHNOLOGY LIMITED, Lancashire (GB)

(21) Appl. No.: 11/597,300

(22) PCT Filed: May 23, 2005
(86) PCT No.: PCT/GB05/02025

§ 371 Date: Jul. 3, 2007

(30) Foreign Application Priority Data
May 25, 2004 (GB) 0411661.2

(51) Int. Cl. F26B 15/18; F26B 5/12

(52) U.S. Cl. 34/498; 34/236; 34/239

(57) ABSTRACT

Drying apparatus comprising an oven drying chamber through which container and, in particular, metal beverage container cans are arranged to pass through. The drying apparatus is for use with in-line can producing apparatus and methods and is arranged to locate down-line from washing apparatus. The drying apparatus is arranged to remove water, chemicals, contaminants etc. from the cans prior to the further processing (e.g. printing) of the cans. The cans are supported on a Kevlar open mesh conveyor belt and a suction chamber is created to draw or attract the cans to the conveyor belt to increase the stability of the cans. Accordingly, this greater stability means that the air pressure of the convecting drying air can be greater when compared to prior art unstabilized drying apparatus.

### FIELD OF THE INVENTION

The present invention relates to drying apparatus and a method of drying and, in particular, although not exclusively to drying apparatus for metal beverage containers and a method of drying metal beverage containers.

### BACKGROUND TO THE INVENTION

The can making process converts a plain coiled metal (aluminium or steel) into a fully finished liquid container (i.e. a can). The can is produced or manufactured through a process of cupping, drawing and ironing of the metal through a series of in-line machinery and is termed DWI (Drawn and Wall Ironed). These “two piece” cans are generally supplied to the beer and beverage can industry. The basic “two piece” can is made up of an open ended can and an end piece. The open ended can generally has a domed bottom end with a necked and flanged upper end. A permanent opening device is attached to the end piece. The end piece is then seamed on to the body of the can following the filling process at the beverage producer's factory/plant.

The can making process includes a washing process following the drawing and wall ironing operation. The washing and a subsequent oven drying stage vary in terms of process and equipment in the can making equipment.

The washing process removes all residues of water and chemicals used in the drawing and wall ironing stages of the process. The washing process generally incorporates several stages of washing and rinsing. In general, there are three or four or more process stages in the washing process and this is generally followed with a “blow off” process and then a washer dryer oven stage in order to produce clean and dry cans which can then be decorated on the outside and coated on the inside.

The can washing and drying process generally includes a pre-wash, a wash, a rinse, surface treatment, rinse, final deionised rinse and then a drying process.

The dryer oven is generally located immediately down line (or down stream) of the washer. The dryer oven is arranged to remove/evaporate any water remaining on the can surface. The complete removal of this moisture is important, particularly for the proper adhesion of the coating and for the prevention of incomplete decoration due to water spots.

The metal temperature condition of the can is important for decorating and can strength and, therefore, the temperature of the dryer oven must be carefully regulated. The cleaned and dried cans (generally referred to as bright cans) are discharged or displaced onto a conveyor system ready for a base coat application.

These typical ovens/dryers are generally used for drying cans and containers on two and three piece beverage and food cans in the metal container/packaging industry. Washer dry off ovens are well known in the art and are widely used in the industry for drying and removing the moisture left or remaining on the inner and outer surfaces of the open ended and partially finished can following the washing operation.

A typical washer dryer oven includes a continuous metal conveyor belt on which the open ended cans stand with the open end being downward. The cans remain upright under their own weight and are conveyed through the dryer. The dryer is generally made up of one, two or three heating zones which are independently heated, generally by gas burners although other heating apparatus may be used, for example, oil burners and electrical heaters.

Each zone in the dryer incorporates an independent exhaust system to remove or evacuate the moisture and contaminants from the oven workspace.

The cans are dried by convection using hot air which is delivered under low pressure through a series of perforated metal sheets. These perforations are generally 0.375 inches in diameter and follow a triangular pattern with a typical free area of 22%, although this may vary considerably.

The length of these typical dryers vary depending upon the can line speed (cans per minute). A typical dryer drying 2000 cans per minute may be over 18 metres in length.

Cans for the beverage and food industry have become lighter in weight and taller in height. This causes a number of problems for the drying apparatus. The air pressure required to dry the cans in an acceptable time and the necessary floor space cannot be obtained due to a number of problems. The stability of the cans cannot be achieved and the cans may blow over at the required pressure which causes scrap waste and spoilage (i.e. the pressure increase causes the cans to fall over). Since the air pressure cannot be achieved the cans may still be wet or moist when they leave the dryer due to inadequate heat transfer. The temperatures in the dryer cannot simply be increased or the metal in the can will be compromised.

The present invention provides drying apparatus and a method of drying for use at the end of the washing process.

It is an aim of the present invention to overcome one problem associated with the prior art whether referred to herein or otherwise.

### SUMMARY OF THE INVENTION

According to a first aspect of the present invention there is provided drying apparatus for containers, the drying apparatus comprising support means to support the containers to be dried, wherein the support means comprises suction means.

Preferably the drying apparatus is arranged, in use to create an area of lower pressure within the or each container in order to draw or bias the or each container towards the support means.

Preferably the suction means biases the containers towards the support means, in use.

Preferably the suction means attracts the containers towards the support means, in use.

Preferably the support means comprises a conveyor belt. The conveyor belt may comprise a mesh and preferably an open mesh. The conveyor belt may comprise Kevlar.

Preferably the container comprise a metal.

Preferably the container comprises food and/or beverage containers.

Preferably the container comprise a can.

Preferably the suction means comprises a plurality of fluid passageways defined in the support means.

Preferably the apparatus comprises a suction chamber arranged, in use, to locate on a first side of the support means. Preferably the containers are supported adjacent to or on a second side of the support means. Preferably the suction chamber is arranged, in use, to draw fluid from the second side of the support means through the fluid passageways to the first side of the support means.

The support means may comprise a support bed. The support bed may comprise one or more rigid support sheets. Preferably the or each rigid support sheet has at least one aperture defined therethrough. Preferably the or each rigid support sheet comprises a plurality of apertures defined therethrough. Preferably the or each rigid support sheet comprises a metal sheet.

Preferably the support bed supports a support surface for the container. Preferably the support surface comprises a surface of a conveyor belt.

Preferably the drying apparatus provides a suction chamber, in use. Preferably the suction chamber is created by fluid flow means comprising a fan. Preferably the suction chamber is arranged, in use, to attract the or each container. Preferably the suction chamber is arranged in use, to draw or bias the or each container towards the support means.

Preferably the distance between the delivery chamber and the support means is adjustable. The drying apparatus may comprise a delivery chamber. Preferably, the delivery chamber locates on a second side of the support means. Preferably a suction chamber locates on a first side of the support means. Preferably the drying apparatus causes air and more preferably hot air to flow from the delivery chamber through the support means to the suction chamber. Preferably in use, the pressure in the suction chamber is less than the pressure in the delivery chamber.

Preferably the delivery chamber comprises fluid delivery means and more preferably air delivery means. The air delivery means may comprise hot air delivery means. The air delivery means may comprise a plenum. The air delivery means may comprise a plurality of delivery nozzles.

Preferably, in use, the drying apparatus causes hot air to flow over the or each container and through the support means. Preferably the flow of hot air through the support means creates an area of lower pressure within a chamber of the or each container.

Preferably the drying apparatus comprises heating means. Preferably the heating means is arranged, in use, to heat air located with the drying apparatus. The drying apparatus may comprise a gas burner.

The drying apparatus may comprise liquid removal means. Preferably the liquid removal means comprises an air knife. Preferably the liquid removal means is arranged, in use, to emit an air supply to an upper surface of the containers. Preferably the distance between the air knife and an upper surface of the containers is adjustable.

According to a second aspect of the present invention there is provided a method of drying containers comprising supporting the containers on support means during drying and wherein the support means comprises suction means.

Preferably the method comprises forming an area of reduced pressure within a chamber provided in the or each container.

Preferably the method comprises forming a partial vacuum within a chamber in the or each container.

### BRIEF DESCRIPTION OF THE DRAWINGS

The preferred embodiments of the present invention will now be described, by way of example only, with reference to the drawings that follow, in which:

FIG. 1 is a side cross-section of a preferred embodiment of drying apparatus.

FIG. 2 is a front cross-section of a preferred embodiment of drying apparatus.

### DESCRIPTION OF THE PREFERRED EMBODIMENTS

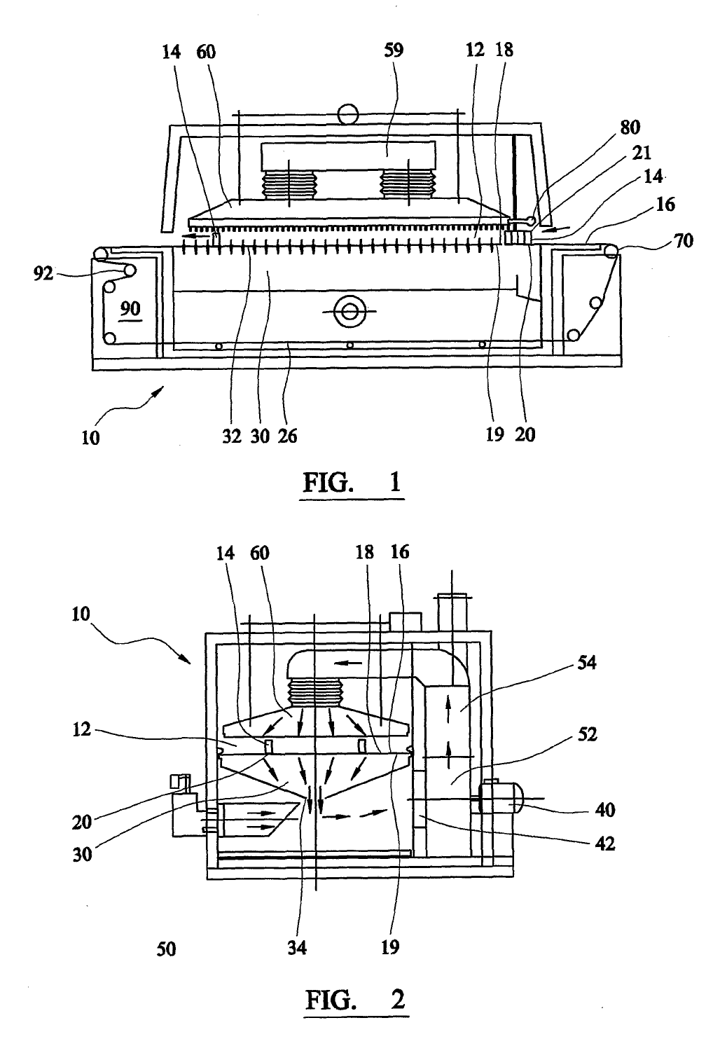

The present invention provides drying apparatus 10 comprising an oven drying chamber 12, as shown in FIG. 1 and FIG. 2. In use, containers and, in particular, metal beverage containers (preferably cans 14 for drinking) are arranged to pass through the drying apparatus 10. As previously explained, the drying apparatus 10 is for use with in-line can producing apparatus and methods and is arranged to locate down-line or downstream from washing apparatus. Accordingly, the drying apparatus is arranged to remove water, chemicals, contaminants and other moisture from the cans 14 prior to the surfaces of the cans 14 being processed further, for example prior to printing the external wall(s) of the cans 14 and coating the internal wall(s) of the cans 14.

The cans 14 are supported on support means in the form of a conveyor belt 16. The conveyor belt 16 comprises a Kelvar open mesh type belt. Accordingly, the conveyor belt 16 defines a plurality (or more specifically numerous) fluid passageways therethrough.

The cans 14 are arranged to be supported on a first side 18 or upper side of the conveyor belt 16 with the open end 20 of the can 14 facing downwardly and resting on the support surface 18 of the conveyor belt 16. The conveyor belt 16 is arranged to move continuously at a constant speed and moves the cans 14 evenly through the drying apparatus 10. The drying apparatus 10 has or creates a suction chamber 30 or suction bed which locates on a second side 19 of the conveyor belt 16. The drying apparatus 10 comprises fluid flow means or suction means in the form of a fan 40 which creates an area of lower pressure within the suction chamber 30. The suction chamber 30 locates on a second side 19 or lower side of the conveyor belt 16 i.e. on the opposite side to the support surface 18 of the conveyor belt 16.

Accordingly, the suction chamber 30 causes fluid or more specifically air to be drawn through the mesh of the conveyor belt 16 and also thereby draws air from within the chambers defined by the open ended cans 14. This thereby draws or attracts the cans 14 towards the support surface 18 of the conveyor belt 16 and thereby increases the stability of the cans 14. Accordingly, this greater stability of the cans 14 means that the air pressure of the convecting drying air can be increased when compared to unstabilised drying apparatus. This thereby allows an increase in the drying air pressure by which the cans 14 can be dried and thereby means that the cans 14 can be dried in a shorter period of time without compromising the temperature condition of the metal in the cans 14.

Accordingly, the drying rate of the cans 14 is significantly increased with respect to prior art can drying ovens. In general, it is the speed of the drying apparatus which dictates the speed and therefore efficiency of can in-line producing machines. Accordingly, the present invention significantly increases the overall efficiency of can production.

The drying apparatus 10 includes heating means in the form of a gas burner 50 which heats the air in the drying oven. The heated air is caused to flow by fluid flow means in the form of a re-circulating fan 40. The air flows from the gas burner 50 through a fluid passageway or conduit 52 into a distribution duct 54. The heated air passes through the distribution duct 54 and into a delivery chamber 60 where the heated air dries the cans 14 and passes through the mesh of the conveyor belt 16 into the suction chamber 30. The air is then drawn through and out of the suction chamber 30 by the recirculation fan 40 and is again heated by the gas burner 50 and is recirculated.

The drying apparatus 10 basically comprises a suction bed chamber, a delivery chamber 60 and a belt conveyor 16. The suction bed chamber incorporates a recirculation fan 40, a gas burner 50, exhaust extraction point(s) and fresh air vent(s). The delivery chamber 60 incorporates a discharge nozzle plenum 62, a supply duct system, an air knife system and an (automatic) adjustable height setting mechanism/system. Finally, the belt conveyor assembly comprises a drive end stand, a tension and automatic belt tracking stand and a Kelvar woven conveyor belt 16.

The suction bed comprises rigid support means in the form of a series of interlocking perforated (316) stainless steel sheets 32 which, together with side guides, locate and move the cans 14 in the correct position. The steel sheets 32 form a continuous support for the Kelvar belt 16 to pass through the drying apparatus 10.

The cans 14 are arranged to be inverted (i.e. with an open end 20 facing downwardly and the dome closed end 21 facing upwardly) on the Kelvar conveyor belt 16 and the cans 14 are conveyed on the conveyor belt 16 through the drying apparatus 10 and pass continuously over the perforated (suction bed) support sheets 32. The perforations on the steel support sheets 32 comprise a series of apertures or holes and in the preferred embodiment comprise holes having a diameter of 6 mm which are arranged in a 19 mm square pattern.

The recirculation fan 40 and the gas burner 50 locate underneath the suction bed created by support sheets 32. In use, the air is drawn down and past over the cans 14 through the suction bed 32 and into the fan inlet 42 and is then discharged by ducting into the delivery chamber.

The drying apparatus 10 is arranged to operate with an air temperature of 200° C., for example the temperature of the air in the oven drying chamber is 200° C. In order to provide the necessary operating temperature, a fully modulating gas burner 50 locates directly opposite the fan inlet 52 and fires or heats directly into the air flow or air stream entering the fan inlet 52. The drying apparatus 10 comprises sensing means in the form of a temperature sensor which measures the temperature of the air in the delivery chamber. The drying apparatus 10 comprises control means which is in communication with the sensing means. The control means is arranged to control the heating means or gas burner 50 in order to increase or decrease the output of the heater 50 in order to maintain the operating temperature, for example to maintain an even and constant operating temperature.

The suction bed chamber 30 includes exhaust means in the form of a separate exhaust extraction point from which a percentage or proportion of “used” air is extracted from the main air stream and is discharged by a separate fan and through ducting into the atmosphere. The fan acts as a positive exhaust for the gas burner purge which is a legal requirement. In addition, the fan balances the drying apparatus 10 in order to prevent the recirculated air becoming saturated. Finally, the fan also ensures that the overall balance of the air system within the dryer apparatus 10 remains negative at all times which thereby prevents “overspoil” at the entry and exit ends.

The suction bed chamber 10 also comprises an adjustable air inlet vent through which a controlled amount of fresh air is allowed to be drawn in. This fresh air replaces the extracted air and maintains the balance within the drying apparatus.

The suction bed chamber also includes baffles 36 and a vent 34 or more specifically return flow balancing bent 34. This vent 34 creates an event return velocity along the length of the dryer and ensures that the return air from the suction chamber does not favour the area closest to the fan. Once through the vent 34, the air can return to the fan at relatively low velocity. In particular, the velocity may be approximately 11 metres per second and the pressure drop may be approximately 74 Pascals.

High velocity through the available area of the suction bed creates a substantial pressure drop through the bed plates 32 which results in high pressures in the suction chamber 30, this negative difference also acts on the area of the can sitting on the bed sheets or conveyor belt 16, thus applying a high negative to the area of the can and holds the can very firm. The delivery chamber 60 impingement nozzles can therefore work at much high velocities than have been possible since lightweight cans have been in use.
Negative pressure with 85% pack=1275 Pascals.
With 0% pack=125 Pascals.

The drying apparatus 10 comprises a delivery chamber 60 which locates directly above the conveyor belt 16 and suction chamber/suction bed 30. The delivery chamber 60 comprises a series of discharge nozzles and preferably a series of discharge slot nozzles which locate on the lower side or underside of the delivery chamber 60. The slot nozzles are arranged transversely across the width of the drying apparatus 10 and more specifically transversely across and above the conveyor belt 16. The nozzles are arranged to emit or release the hot air from the recirculation fan 40 over the cans 14. Accordingly, the delivery chamber 60 is connected to the recirculation fan 40 by a delivery duct 54. The nozzles are arranged to emit the hot air at a specific velocity in order to achieve the most efficient drying possible. The nozzles are provided on a sheet or more specifically a plenum.

The spacing (or more specifically the vertical distance) between the delivery chamber 60 and the conveyor belt 16 and/or suction chamber 30 is adjustable. In particular, the delivery chamber 60 and/or nozzles plenum is adjustable relative to the conveyor belt 16 in the vertical plane to allow for different heights of cans 14. The delivery chamber 60 is connected or mounted to movement means in order to raise the delivery chamber or to lower the delivery chamber 60. The movement means comprises a securement member or members which is or are linked to the delivery chamber 60 by mounting means. The variable height positions of the delivery chamber 60 are programmed and controlled by control means which comprises a control panel. The user can simply select the size (height) of the can 14 to be dried in the drying apparatus 20 and the control means will automatically position the delivery chamber 60 relative to the conveyor belt 16 in order for use with that particular size of can 14. In addition, the movement means also automatically adjusts the height or vertical position of the air knife 80.

The delivery chamber 60 comprises fluid or liquid removal means at an entry portion thereof. The liquid movement means is arranged to remove any liquid or excess water in the concave part of the end of the can blanks facing upwardly. The liquid removal means comprises an air knife 80. The air knife 80 is located at the entry end of the dryer 10 and is provided in a compartment or a pre-section of the drying apparatus 10 and is designed to impinge air on the top (inverted) dome of the cans 14 as the cans 14 pass below the air knife 80. The air knife 80 simply blows the excess water out of the concave part of the dome of the can 14. The water is taken beneath to a drain point and the air is drawn back into the suction chamber 30 which is under negative pressure.

The drying apparatus 10 includes fluid flow rate control means which is arranged to control the flow rate through the supply ducting 34 supplying the hot air to the delivery chamber 60. In particular, the fluid flow rate control means comprises a variable rate damper which varies and alters the discharge velocity from the supply nozzles. This velocity control means allows the drying apparatus 10 to compensate for the difference in weight of different cans 14 and, in particular, to compensate for the weight difference between steel cans and aluminium cans. This effectively “fine tunes” the drying apparatus 20 for individual situations dependent upon the requirements.

The belt conveyor system comprises a continuous Kevlar belt 16. The belt conveyor system also includes a drive stand 90 with a motor gearbox and auto-tensioning apparatus 92 (pneumatic tensioner) at the exit (or output) end of the drying apparatus and an automatic belt tracking unit 70 (pneumatic auto-tracker) at the entry (or input) end of the drying apparatus 10. The conveyor belt 16 comprises an open mesh design with a weave which is arranged to create a 4 mm square open area between the strands of the fibre. The belt 16 is arranged to return within the drying apparatus 10 in order to conserve as much heat as possible. The use of a Kevlar open-mesh type belt enables the negative pressure to be applied to the area of the can through the bed plates and through the belt mesh.

The free area of the suction bed (i.e. the free area defined in the support sheet(s) 32) is designed so that under an 85% pack density of cans, the reduced free area of the suction bed increases the velocity of the air travelling down through the bed and over and past the cans 14. This increased velocity, whilst retaining the same overall fan volume, increases the pressure drop through the bed and results in a significantly higher negative pressure drop through the bed and thereby results in a significantly higher negative pressure being applied overall to the whole under surface of the suction bed. When the cans 14 are supported on the conveyor belt 16, the apertures in the perforated suction bed (i.e. the support sheet 32 and the conveyor belt 16) then transfer or apply the same negative pressure to the underside of the cans 14 which thereby holds the cans 14 down on to the conveyor belt 16 with considerable force.

The recirculation fan 40 volume remains the same regardless of the number of cans 14 on the conveyor belt 16. The fan 40 is selected to supply a set volume even whilst under increased load from the pressure drop through the suction bed. This results in a constant supply volume being delivered to the delivery nozzles which is not affected even if the density of the cans changes.

Accordingly, during normal operation, with an 85% pack density, the hot air being delivered on to the cans 14 does not cause any instability and consequently allows relatively high impingement hot air velocities to be used.

This, therefore, decreases the length of the drying apparatus 10 compared to prior art drying ovens due to the increased drying efficiency.

In the preferred embodiment the suction bed is arranged to provide a pressure difference between the suction chamber 30 and the delivery chamber 60 or to have a negative pressure of 1275 Pascals with a can pack density of 85% and a negative pressure of 125 Pascals with no cans present. The resultant air velocities through the perforated sheets of the suction bed are substantially 45.63 metres per second with a pack density of 85% and approximately 12.26 metres per second with no cans present. The velocity through the vent 34 is approximately 11 metres per second.

The resultant suction force on the area of the can 14 on the suction bed with 85% can pack density creates an attractive suction force (or holding down force) on each can 14 which is equivalent to a weight of 445 grammes. This can be calculated since the can diameter is 66 mm which means that the can area sat on the conveyor belt 16 above the suction bed is 3421.19 mm². The negative pressure is 1275 Pascals which is equivalent to 0.13 grammes force/mm². Therefore, the total suction force is 3421.19×0.13 which equals 445 grammes per can with an 85% pack density.

Accordingly, the resultant force holds the cans 14 firmly in position on the belt 16 whilst being subjected to hot air delivered by the delivery nozzles the air knife 80.

The suction force varies in proportion to the pack density i.e. with only one can 14 the suction force would be 125 Pascals which is equivalent to 0.012 grammes/mm² and the suction force would be 0.012×3421.19 which is equal to 43.61 grammes.

The weight of a typical steel can is 25 grammes whereas the weight of a typical aluminium can (e.g. 440 ml) is 14.7 grammes. Accordingly, it can be seen that the suction means significantly increases the effective weight of each can 14 and this may be in the region of 30 times an increase in weight for each can.

Accordingly, even with reduced pack densities, the suction force available is significant and considerable, and allows the discharge hot air velocity impinging on the cans 14 to be significantly higher than a conventional washer dryer.

The discharge velocity of the hot air through the delivery nozzles is in the region of 12 metres per second to 15.5 metres per second. The resultant delivery chamber 60 positive pressure is therefore between 88 Pascals and 147 Pascals. The distance between the delivery nozzles and the upper ends or surfaces of the cans is substantially 45 mm. The height of distance between the conveyor belt 16 and the delivery nozzles is adjustable between 160 mm and 265 mm to allow for different sized containers or cans 14. In the preferred embodiment, the velocity of the air from the air knife 80 is substantially 15.5 metres per second.

The preferred embodiment may be used with typical 440 ml beverage steel cans 14 (for example beer cans 14). The drying apparatus may be designed to dry 4000 cans per minute and have a 2.5 metre wide suction bed or conveyor belt 16. Accordingly there will be 556 cans per metre based on an 85% pack density. Accordingly, this provides a drying time of 45 seconds including the initial dome “blow off”. Accordingly, the overall length of the drying apparatus will be 4000 divided by 556 multiplied by 45/60 which is equal to 5.39 metres.

The number of cans per minute based on a 2.5 metre wide suction bed will be as follows:

$$Dryer length ( in meters ) \times \frac{60}{45} \times 556 = Number of cans per minute$$

For example:

$$4 m dryer = 4 \times \frac{60}{45} \times 556 = 2965 cans per minute$$

$$5 m dryer = 5 \times \frac{60}{45} \times 556 = 3706 cans per minute$$

$$6 m dryer = 6 \times \frac{60}{45} \times 556 = 4448 cans per minute$$

Energy (based on 4000 steels cans per minute dryer with 2.5 metre bed width)
Can weight=24.3 grammes
Specific heat of steel=0.117 btus/lb/degrees F.
Heat requirement for cans only=overall mass×temp·rise×sp·ht of steel
4000×24.3×60=5832 kg/hr mass (12830.4 lbs/hr)
Ingoing temp of cans=20C (68F)
Temp. reqd=200C (392F)
Rise=180C (324F)
Using Imp. units energy reqd=12830.4×324×0.117=486375 btus/hour (143 kW)
Evaporation of Water
Water per can wet=2.52 grammes per can.

$$\begin{matrix}4000 cans = 10080 grammes of water \text{/} min \\ = 604.8 kg per hour ( 1331 lbs ) \\ Using Imps Units energy reqd \\ = 1331 \times 324 \times 1 = 431244 btus \text{/} hr \\ ( 126.38 kW ) \\ Heat losses from dryer skin \\ ( based on 377 btus \text{/} sq meter \text{/} hr ) \\ = 20306 btus \text{/} hr ( 5.951 kW )\end{matrix}$$

Heat loss through exhaust=approx 10% max=27 kW
Therefore, total heat requirement=142 kW+126.38 kW+5.951 kW+27 kW=300 kW
Recirculation Fan Volume (based on the 4000 cans/min example)=40528 cubic metres/hour
Exhaust fan volume=4000 cubic metres/hour

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-27. (canceled)

28. A drying apparatus for containers, the drying apparatus comprising support means to support the containers to be dried, wherein the support means comprises suction means.

29. The drying apparatus according to claim 28, wherein the drying apparatus is arranged, in use, to create an area of lower pressure within the or each container in order to draw or bias the or each container towards the support means.

30. The drying apparatus according to claim 28, wherein the suction means biases the containers towards the support means, in use.

31. The drying apparatus according to claim 28, wherein the support means comprises a conveyor belt.

32. The drying apparatus according to claim 31, wherein the conveyor belt comprises a mesh.

33. The drying apparatus according to claim 31, wherein the conveyor belt comprises Kevlar.

34. The drying apparatus according to claim 28, wherein the container comprises a metal.

35. The drying apparatus according to claim 28, wherein the container comprises food and/or beverage containers.

36. The drying apparatus according to claim 28, wherein the suction means comprises a plurality of fluid passageways defined in the support means.

37. The drying apparatus according to claim 28, wherein the apparatus comprises a suction chamber arranged, in use, to locate on a first side of the support means.

38. The drying apparatus according to claim 28, wherein the containers are supported adjacent to or on a second side of the support means.

39. The drying apparatus according to claim 28, wherein the drying apparatus comprises a delivery chamber.

40. The drying apparatus according to claim 39, wherein the delivery chamber locates on a second side of the support means.

41. The drying apparatus according to claim 39, wherein a suction chamber locates on a first side of the support means.

42. The drying apparatus according to claim 39, wherein the drying apparatus causes hot air to flow from the delivery chamber through the support means to the suction chamber.

43. The drying apparatus according to claim 39, wherein the pressure in the suction chamber is less than the pressure in the delivery chamber.

44. The drying apparatus according to claim 28, wherein the drying apparatus causes hot air to flow over the or each container and through the support means.

45. The drying apparatus according to claim 44, wherein the flow of hot air through the support means creates an area of lower pressure within a chamber of the or each container.

46. The drying apparatus according to claim 28, wherein the drying apparatus comprises heating means.

47. The drying apparatus according to claim 28, wherein the drying apparatus comprises liquid removal means.

48. The drying apparatus according to claim 47, wherein the liquid removal means comprises an air knife.

49. The drying apparatus according to claim 47, wherein the liquid removal means is arranged, in use, to emit an air supply to an upper surface of the containers.

50. A method of drying containers comprising supporting the containers on support means during drying and wherein the support means comprises suction means.

51. The method of drying containers according to claim 50, wherein the method comprises forming an area of reduced pressure within a chamber provided in the or each container.

52. The method of drying containers according to claim 51, wherein the method comprises forming a partial vacuum within a chamber in the or each container.
